(19) United States
(12) Patent Application Publication
(10) Pub. No.: US 2007/0183142 A1
(43) Pub. Date: Aug. 9, 2007

(54) MP3 and/or MP4 player flashlight device

(76) Inventors: Barbara Mobille Bollman, Bethesda, MD (US); David Hoffman, Bethesda, MD (US); William H. Bollman, Bethesda, MD (US)

Correspondence Address: MANELLI DENISON & SELTER PLLC, 7th Floor, 2000 M Street, N.W., Washington, DC, 20036-3307, US

(21) Appl. No.: 11/349,925

(22) Filed: Feb. 9, 2006

(51) Int. Cl. F21L 4/00

(52) U.S. Cl. 362/157

(57) ABSTRACT

A high-intensity LED is integrated into an MP3 player such as an iPod™ device to provide an extremely convenient flashlight functionality at the ready for a user, particularly useful in emergency situations. When an emergency or other need emerges suddenly and while the user is otherwise unable to obtain a conventional flashlight, use of an MP3 player flashlight device provides a useful source of light for both comfort and safety of the user. In another aspect of the invention, the MP3 player flashlight is a peripheral device connected to a digital port of the MP3 player. Alternatively, the flashlight is formed in such a shape as to fit into an external memory card slot of an MP3 player (e.g., in the shape of a SmartCard), drawing power and even control from the MP3 player through the connector otherwise intended for a memory card.

### BACKGROUND OF THE INVENTION

1. Field of the Invention

This invention relates to handheld MP3 and MP4 player devices. More particularly, it relates to peripheral devices integrated into an MP3 and/or MP4 player device.

2. Background of Related Art

Flashlights are well known devices. They are used to illuminate surrounding objects and/or an oncoming pathway. They are used to provide the feeling of safety in a dark room. Some children even use them as a nightlight.

While flashlights are useful devices, not all people carry one at all times. In fact, most people do not carry a flashlight at all times. Rather, many people keep a flashlight in an easily accessible location should the need arise.

In today's ever-mobile society, one finds themselves often not at home, near their flashlight. For instance, should the need arise for a flashlight while on a family vacation away from home, one would need to obtain one from a store, hotel concierge, etc. This is not always the most convenient method. Moreover, in extreme needs such as a power outage, the demand for flashlights is high. If you don't get to a store immediately to buy a flashlight (presuming that the store is open during the power outage), they will more than likely be sold out.

Existing flashlights are bulky, formed from relatively unreliable incandescent bulbs, and are mechanically operated, again adding to unreliability, bulk and costs.

In short, when away from home, unless you carry a flashlight with you at all times, obtaining one during a time of need will be at best inconvenient. There is a need for a convenient and functional illumination device that will have a likelihood of availability in your moment of need.

### SUMMARY OF THE INVENTION

In accordance with the principles of the present invention, in an MPEG digital file entertainment player device, the improvement comprises a light emitting diode (LED) flashlight powered by a battery used to also power the MPEG digital file entertainment player device. The LED flashlight is operable under software control.

In accordance with another aspect of the present invention, an MP3 player comprises an MPEG-3 (MP3) file player functionality module. A light emitting diode (LED) flashlight is operable under software control. A battery is adapted to power both the MP3 file player functionality module and the LED flashlight.

In yet another aspect, an MP3 player flashlight comprises a flashlight, and a connector interface adapted for interconnection with, and software control through, a digital port of an MP3 player.

Yet other aspects include a method and means for providing illumination of objects surrounding an MP3 player. In this aspect, at least one button on an MP3 player is activated to cause software control to turn on a flashlight integrated within the MP3 player. Current is caused to flow through the flashlight, thus providing illumination of objects surrounding the MP3 player for a user of the MP3 player.

### BRIEF DESCRIPTION OF THE DRAWINGS

Features and advantages of the present invention will become apparent to those skilled in the art from the following description with reference to the drawings, in which:

FIG. 1 shows an exemplary MP3 player flashlight device including an LED flashlight initiated via a mechanical switch integrated in the MP3 player, in accordance with the principles of the present invention.

FIG. 2 shows an exemplary MP3 player flashlight device including an LED flashlight controlled via a software menu setting, in accordance with the principles of the present invention.

FIG. 3 shows a functional schematic diagram for the exemplary MP3 player flashlight device shown in FIG. 2.

FIG. 4 shows an exemplary method of turning the flashlight of an MP3 player flashlight device ON and OFF through software control, in accordance with the principles of the present invention.

### DETAILED DESCRIPTION OF THE ILLUSTRATIVE EMBODIMENTS

MPEG-3 (MP3 ) player devices have become ubiquitous with everyday life. Many people carry them constantly. The present invention mates the high likelihood that a user will have an MP3 player device in a time of need for a flashlight, and the functionality of a flashlight.

In accordance with the principles of the present invention, a high-intensity white LED is integrated into an MP3 (and/or MPEG-4) player device to provide an extremely convenient flashlight functionality at the ready for a user in possession of their MP3 player device, particularly useful in emergency situations. When an emergency or other need emerges suddenly and while the user is otherwise unable to obtain a conventional flashlight, use of an MP3 and/or MP4 device provides a useful source of light for both comfort and safety of the user of the MP3/MP4 device.

MP3, MP4, and other audio and/or video digital compression techniques for the purpose of minimizing file size are collectively referred to herein simply as an ‘MP3 player’. It will be understood by those of ordinary skill in the art that the invention relates equally to digital audio-only MP3 players, as it does to digital audio and video players capable of playing MP3 and MP4 files.

In another aspect of the invention, the MP3 player flashlight may be provided in or near a digital port of a wireless phone. Alternatively, the LED flashlight is formed in such a shape as to fit into an external memory card slot of a target MP3 player device (e.g., in the shape of a SmartCard™), drawing power and even control from the MP3 player through the connector otherwise intended for a memory card.

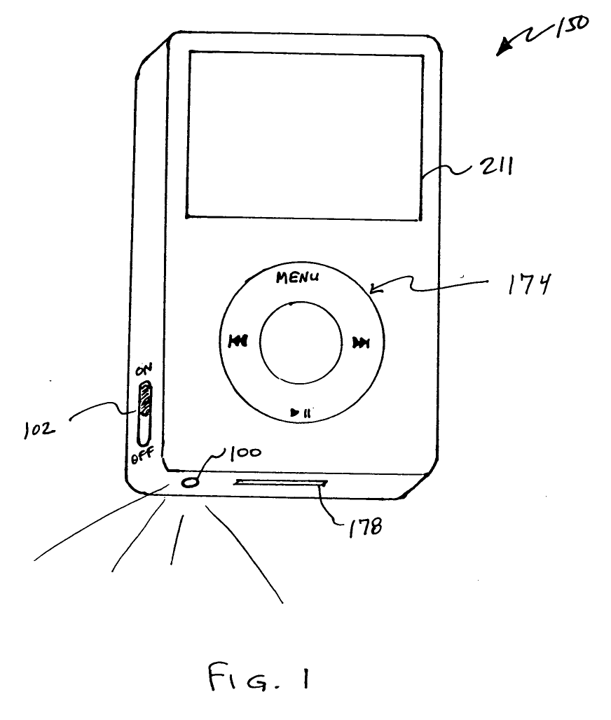

FIG. 1 shows an exemplary MP3 player flashlight device including an LED flashlight initiated via a mechanical switch integrated in the MP3 player, in accordance with the principles of the present invention.

In particular, FIG. 1 shows a MP3 player flashlight device 150 including a flashlight 100. In the disclosed embodiment, the MP3 player flashlight device 150 includes an iPod™ MP3 device commercially available from Apple Computer, Inc. of Cupertino, Calif., United States. Such iPod™ device may be capable of playing audio only (e.g., an MP3 digital audio file player) or video and audio (e.g., an MP3 and MP4 digital audio file player).

In the given embodiment, a software-detected button 102 causes operation of the illuminating high-intensity light-emitting-diode (LED) forming the flashlight 100. Of course, the button 102 may be replaced by a sequence of presses of an appropriate keypad or other conventional buttons, including touch-sensitive finger movement, such as would be necessary to navigate through a menu-driven user interface to select operation of the flashlight 100.

It is important that the flashlight 100 be operated under the control of software, instead of mechanically operated directly between an ON/OFF switch and power to the flashlight LED, to allow intelligent battery conservation. For instance, as the battery nears depletion, if the flashlight 100 is at the time in an ON condition, it is desirable to automatically turn the flashlight 100 OFF, so as to maximize the ability to perform minimal operations of the compressed audio and/or video file player functions in a low-battery condition.

The flashlight 100 may be physically located on any suitable external surface of the MP3 player flashlight device 150. This includes location on an iPod™ device as shown in FIG. 1.

The illuminating element of the flashlight 100 is preferably a light emitting diode (LED), and more preferably a high intensity white LED. A high-intensity white LED or other high-intensity solid state white light illumination device is much preferred by the present inventors for its reliability, long rated lifetime, as well as its ease of integration into circuit board manufacture. Incandescent bulbs are larger, have much shorter lifespans, are relatively unreliable, are difficult if at all possible to mount directly to a printed circuit board (adding costs), and require replacement, making them undesirable in the present application.

The particular high-intensity white LED or other illuminating element is preferably selected based on the available battery power supply level (e.g., 2.4V, 3.7V, 5V, 12V, etc.) in the MP3 player, the desired illumination intensity at that available power supply level, reliability, and to a lesser extent rated lifetime (presuming the lifetime of the high-intensity white LED will be much longer than its expected use).

A small reflector may be formed behind the high-intensity white LED of the flashlight 100, to maximize the projection, and focus, of the illumination in a desired direction. The reflector may be formed into a small cavity formed in the metal case of the iPod™ or in the metal or plastic of other MP3 devices 150. In the case of a plastic case, the small cavity is preferably coated with a highly reflective coating.

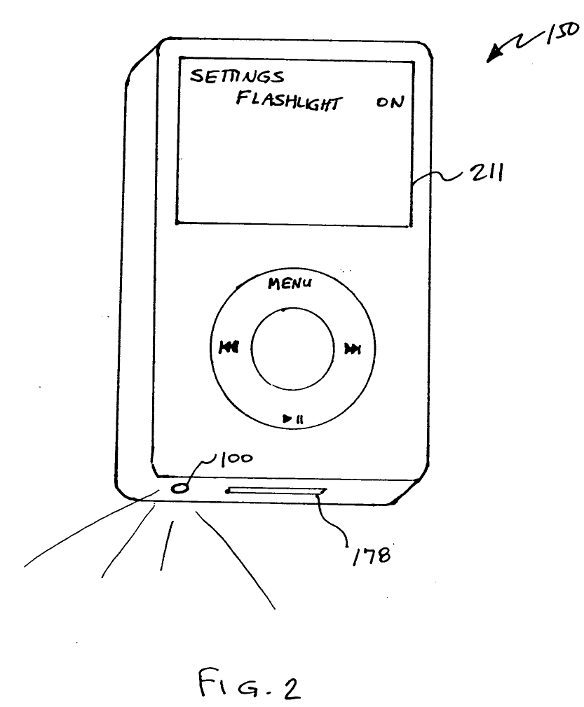

FIG. 2 shows an exemplary MP3 player flashlight device including an LED flashlight controlled via a software menu setting, in accordance with the principles of the present invention.

In particular, as shown in FIG. 2, the mechanical switch 102 may be replaced by the availability of a software setting such as in a settings menu that allows the user of the MP3 player to easily turn the flashlight 100 ON or OFF through software control.

Alternatively, the availability of a menu setting to turn the flashlight 100 ON or OFF shown in FIG. 2 may be implemented in combination with the availability of a mechanical switch 102 shown in FIG. 1, either one of which having the ability to instruct the software to turn the flashlight 100 ON or OFF. In such case, the menu setting shown in FIG. 2 may be used to enable the switch 102 shown in FIG. 1 to work.

For instance, if the menu setting shown in FIG. 2 is set to turn the flashlight 100 ON, then the flashlight 100 will turn ON when the switch 102 is set to the ON position and OFF when the switch 102 (FIG. 1) is set to its OFF position. On the other hand, when the menu setting shown in FIG. 2 is set to turn the flashlight OFF, then the external switch 102 will be disabled, or otherwise rendered non-functional for the purposes of turning the flashlight 100 ON or OFF.

In yet another embodiment, with an appropriate menu setting to enable the flashlight to an ON condition such as shown in FIG. 2, then an external switch otherwise used for a different function may be changed to function as a switch for the flashlight. For instance, a conventional iPod™ compressed digital audio and/or video file player includes a mechanical HOLD switch (not shown) that conventionally disables functionality of all external user interface controls. This is well suited to help avoid unintentional turning ON of the iPod™ device, such as when it is being carried in a purse or pocket. In the present embodiment, when the flashlight menu setting is set to an ON condition, then the HOLD switch will function to turn ON the flashlight 100. When in this flashlight-enabled condition, the HOLD switch may continue to function as it does conventionally, i.e., to disable external user interface controls, though in this mode it may alternatively function only to control the flashlight 100 and not to disable external user interface control, in accordance with the principles of the present invention.

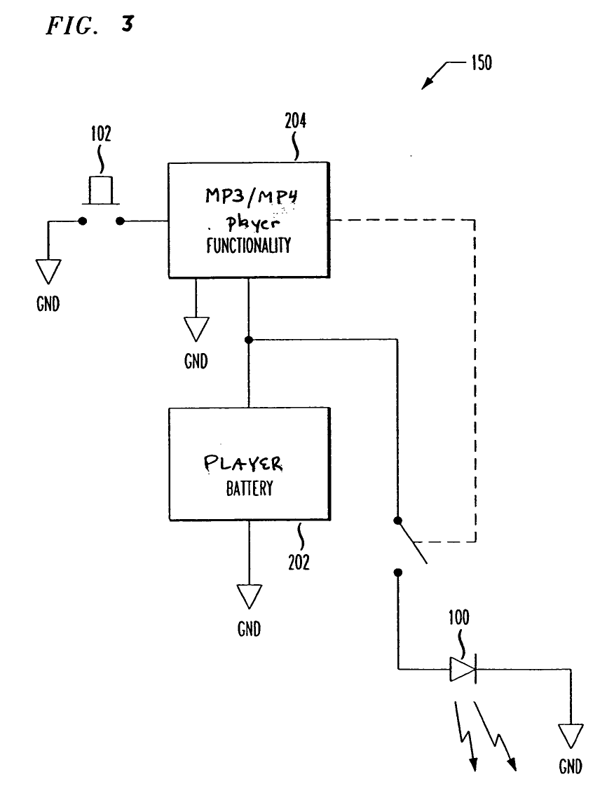

FIG. 3 shows a functional schematic diagram for the exemplary MP3 player flashlight device shown in FIG. 2.

In particular, as shown in FIG. 3, the LED of the flashlight 100 is powered from an MP3 player battery 202, which also powers the compressed digital audio and/or video file player functionality 204 in the MP3 player flashlight device 150. In the given embodiment, the flashlight 100 is controlled ON and OFF by operation of software of the MP3 player (e.g., iPod™).

The switch 102 shown in FIG. 3 can be a mechanical switch sensed by software, or a virtual switch operated through a defined series of alphanumeric or other keys on the otherwise conventional wireless phone, or through checkbox type selection in an appropriate pull-down or other type menu in a graphical user software interface.

The switch 102 (whether mechanical or virtual) may operate as a momentary type switch, or as an ON/OFF type switch. A momentary function would turn the flashlight 100 ON only while the switch 102 is activated: when released, the flashlight 100 would turn off. If an ON/OFF type switching function, the flashlight 100 would turn ON when the switch 102 is activated, and remain ON until the switch 102 is deactivated, at which time the software would cause current to cease flow to the flashlight 100, which would then be turned OFF.

The switch 102 is preferably a virtual switch, operable under software control. In the disclosed embodiment, the switch 102 is activated and deactivated through a predefined series of control sequences input on the user interface 174 (FIG. 1) that navigates a user through one or more pages of a menu through a graphical user interface (GUI) on a screen 211 (FIG. 1) of the MP3 player flashlight device 150. For instance, a user may navigate to a SETTINGS menu for their wireless phone, and select a checkbox, or alternate setting, to turn the flashlight ON. Normal MP3, MP4 or other compressed digital file player functionality is preferably possible at all times. Thus, a song, movie, Podcast, etc., may be played while the flashlight 100 is turned ON. For convenience, and for battery conservation, it may be preferable to automatically turn the flashlight 100 OFF during active audio or video file play. In such a case, it may also be preferable to automatically turn the flashlight 100 back ON after the phone call, if the switch 102 (e.g., menu setting) remains activated.

Preferably, the flashlight 100 is controlled ON and OFF through a software controllable element, to allow automatic shut OFF of the flashlight 100 if and when the battery power becomes low. An element such as a power transistor or other transistor may form a virtual switch to turn the flashlight 100 ON and OFF, though mechanical switching of the flashlight 100, e.g., using a mechanical relay, is also within the spirit of the present invention.

The software controllable element to power the flashlight 100 ON and OFF can be a transistor of any suitable type, e.g., CMOS, MOSFET, etc., that is rated to sufficiently and reliably control current to the LED of the flashlight 100.

Preferably the MP3 player remains functional and capable of playing an audio and/or digital file while the flashlight 100 is ON. In one aspect, if an audio or video file is selected for play, the flashlight 100 may be automatically turned OFF while the file is being played. Similarly, and/or alternatively, the flashlight 100 may be turned OFF when the selected audio or video file(s) finish(es) playing.

The flashlight 100 may be turned OFF when the MP3 player flashlight device 150 is powered down. If desirable, the flashlight 100 may then remain OFF even after powering the MP3 player flashlight device 150 back up, providing a convenient way to turn the flashlight 100 OFF after use.

The flashlight 100 may be automatically powered OFF when the battery 202 is detected to have less than a threshold amount of power remaining. If the flashlight 100 is to be powered OFF in such case, preferably a warning sound and/or textual message will be provided to the user of the MP3 player flashlight device 150 providing them warning beforehand.

The high-intensity white (or natural) light of the flashlight 100 is preferably an LED, and more preferably an LED providing light primarily in the visible spectrum (e.g., a white LED), and one that is intended for use to provide visual illumination of surrounding objects a significant distance from the LED, e.g., at least several feet, as is typical for use as a flashlight.

While a single LED is shown in the flashlight 100 in FIG. 3, more than one LED may be used to provide additional light intensity.

Current to the flashlight 100 may be a constant current to provide maximum intensity. However, to conserve battery power, the flashlight 100 may be powered with a pulsed current (e.g., a less-than-100% duty cycle current pulse such as a 50% duty cycle current pulse). The pulse is preferably a square wave pulse, though an AC sine wave pulse is also possible and within the spirit of the present invention.

The battery 202 is preferably an integrated battery used for otherwise conventional wireless phone functionality (e.g., Li-ion, NiMH, etc.)

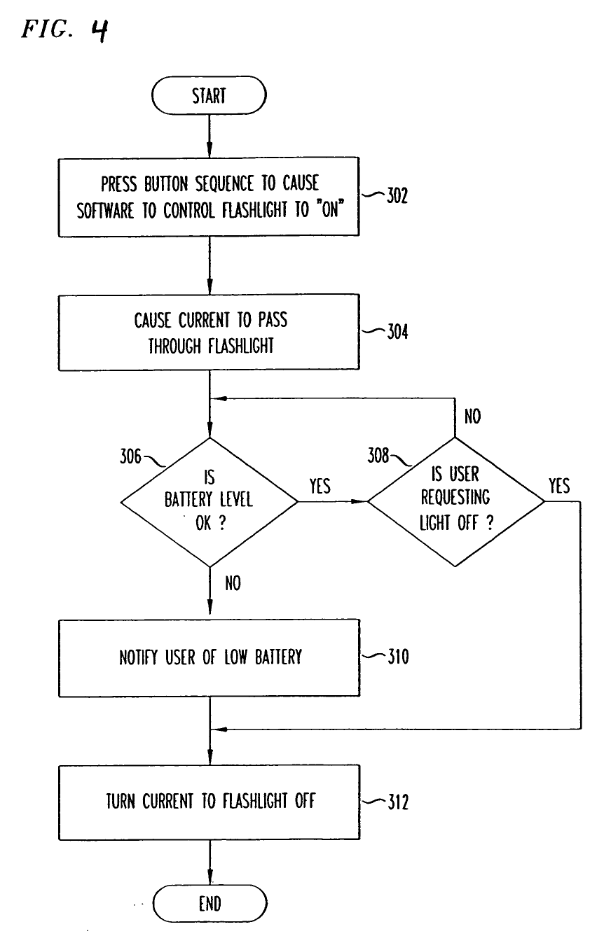

FIG. 4 shows an exemplary method of turning the flashlight of an MP3 player flashlight device ON and OFF through software control, in accordance with the principles of the present invention.

In particular, as shown in step 302 of FIG. 4, a button (or sequence of buttons such as navigating through a menu) is pressed to cause software operating on the MP3 player flashlight device 150 to control the flashlight 100 to an ON or illuminating condition.

In step 304, in response to the user command to cause software to control the flashlight 100 to an ON condition, current is caused to pass through the flashlight 100, thus turning the flashlight 100 ON. The current is preferably caused to pass through the flashlight 100 using an appropriate transistor device.

Step 306 is useful to conserve battery power when the voltage level of the battery 202 drops to a very low (i.e., almost depleted) state. In step 306, the control element of the MP3 player flashlight device detects the level of power remaining in the battery 202 in an otherwise conventional manner.

If the battery level is detected as being OK, or above a given low power threshold, then the method loops. In the endless loop, additional operations may be sensed on the MP3 player flashlight device 150, such as if/when the user has pressed a button or buttons indicating that they want the flashlight 100 turned OFF, as shown in step 308.

If the battery level is detected as being below a given low power threshold, then the method of FIG. 4 jumps to step 310, where the user is notified of the low battery condition with an audible and/or visual warning. Of course, such notification is desirable, but not absolutely necessary. Then the current switch allowing current to flow through the flashlight 100 is opened, or turned OFF, ceasing battery usage by the flashlight 100 and also the illumination provided thereby. The flashlight 100 is thus turned OFF.

While the present invention is shown in its preferred form with the flashlight 100 integrated within the body of an otherwise conventional MP3 and/or MP4 player device (e.g., an iPod™ device), a less desirable embodiment may be utilized wherein the flashlight 100 is installed post-manufacture of an otherwise conventional MP3 player. For instance, the flashlight 100 may be installed into a digital port (e.g., a Universal Serial Bus (USB) port), memory card slot, etc.) For instance, the flashlight 100 may be formed in a device that inserts into a digital port 178 (FIG. 1).

In any event, it is important that the flashlight 100 be non-bulky, and essentially not noticed by the user until the time in which they need it. Thus, if the flashlight 100 is such a post-manufacture device, it is important that the flashlight 100 be integral to the MP3 player, and non-encumbering. It is important that the flashlight be unobtrusive, and essentially unnoticed by the user—until the time in which the user has need for the flashlight 100.

In such an embodiment, power is drawn from the device battery through the digital port or memory card slot, whichever is used to power and control operations of the flashlight 100. Software control of the flashlight 100 is also passed through the digital port or memory card slot in such embodiment.

Operation of such a peripheral flashlight 100 is preferably via software in the MP3 player that controls the digital port in such a way as to operate the flashlight 100 ON and OFF through a menu selection or other software-detected button sequence.

The peripheral flashlight may alternatively be formed largely in the shape and/or size of an external memory card utilized by the wireless phone, e.g., a SmartCard or other standardized memory card. Such peripheral would preferably include a connector commensurate with the connector of a suitable memory card, utilizing necessary signals such as power and ground. The memory card-shaped peripheral is inserted into an otherwise conventional MP3 player in place of a memory card, and operated as described with respect to the techniques shown in FIG. 4.

An MP3 device, MP3 and/or MP4 device, compressed digital audio and/or video file player device, as used herein all refers to a portable, battery powered entertainment device capable of playing MPEG audio or video files, most notably, but not necessarily, an iPod™ device.

While the invention has been described with reference to the exemplary embodiments thereof, those skilled in the art will be able to make various modifications to the described embodiments of the invention without departing from the true spirit and scope of the invention.

What is claimed is:

1. In an MPEG digital file entertainment player device, the improvement comprising:
a light emitting diode (LED) flashlight powered by a battery used to also power said MPEG digital file entertainment player device;
wherein said LED flashlight is operable under software control.

2. In an MPEG digital file entertainment player device according to claim 1, wherein:
said MPEG digital file entertainment player device is an MP3 player.

3. In an MPEG digital file entertainment player device according to claim 1, wherein:
said MPEG digital file entertainment player device is an MP4 player.

4. In an MPEG digital file entertainment player device according to claim 1, wherein:
said MPEG digital file entertainment player device is an MP3 and MP4 player.

5. In an MPEG digital file entertainment player device according to claim 1, wherein:
said LED flashlight is integrated within a case of said MPEG digital file entertainment player device.

6. In an MPEG digital file entertainment player device according to claim 1, wherein said LED flashlight comprises:
a high intensity white LED.

7. An MP3 player, comprising:
an MPEG-3 (MP3) file player functionality module;
a light emitting diode (LED) flashlight operable under software control; and
a battery adapted to power both said MP3 file player functionality module and said LED flashlight.

8. The MP3 player according to claim 7, further comprising:
a software menu adapted for controlling said LED flashlight to ON and OFF conditions.

9. The MP3 player according to claim 7, wherein:
said LED flashlight is integrated within said MP3 player.

10. The MP3 player according to claim 9, wherein said LED flashlight comprises:
a high intensity white LED.

11. An MP3 player flashlight, comprising:
a flashlight; and
a connector interface adapted for interconnection with, and software control through, a digital port of an MP3 player.

12. The MP3 player flashlight according to claim 11, wherein:
said MP3 player flashlight is shaped to fit in an external memory card slot of said MP3 player.

13. A method of providing illumination of objects surrounding an MP3 player, comprising:
activating at least one button on an MP3 player to cause software control to turn on a flashlight integrated within said MP3 player; and
causing current to flow through said flashlight, thus providing illumination of objects surrounding said MP3 player for a user of said MP3 player.

14. The method of providing illumination of objects surrounding an MP3 player according to claim 13, wherein:
said flashlight is a light emitting diode (LED) flashlight.

15. The method of providing illumination of objects surrounding an MP3 player according to claim 14, wherein:
said step of activating comprises navigating through at least one page of a menu driven graphical user interface.

16. The method of providing illumination of objects surrounding an MP3 player according to claim 13, further comprising:
automatically powering said flashlight OFF when a battery power level serving both a compressed digital file player functionality and said flashlight drops below a predetermined low power threshold level.

17. Apparatus for providing illumination of objects surrounding an MP3 player, comprising:
means for activating at least one button on an MP3 player to cause software control to turn on a flashlight integrated within said MP3 player; and
means for causing current to flow through said flashlight, thus providing illumination of objects surrounding said MP3 player for a user of said MP3 player.

18. The apparatus for providing illumination of objects surrounding an MP3 player according to claim 17, wherein:
said flashlight is a light emitting diode (LED) flashlight.

19. The apparatus for providing illumination of objects surrounding an MP3 player according to claim 18, wherein said means for activating comprises:
means for navigating through at least one page of a menu driven graphical user interface.

20. The apparatus for providing illumination of objects surrounding an MP3 player according to claim 17, further comprising:
means for automatically powering said flashlight OFF when a battery power level serving both a compressed digital file player functionality and said flashlight drops below a predetermined low power threshold level.
